(19) United States
(12) Patent Application Publication
(10) Pub. No.: US 2007/0156553 A1
(43) Pub. Date: Jul. 5, 2007

(54) Credit Proxy System and Method

(76) Inventor: Stuart Zimmerman, Hollison, MA (US)

Correspondence Address: Brian M. Dingman, Esq.;Mirick, O'Connell, DeMallie & Lougee, 1700 West Park Drive, Westborough, MA, 01581, US

(21) Appl. No.: 11/609,016

(22) Filed: Dec. 11, 2006

Related U.S. Application Data
(60) Provisional application No. 60/751,416, filed on Dec. 15, 2005.
(60) Provisional application No. 60/795,232, filed on Apr. 26, 2006.

(51) Int. Cl. G06Q 40/00

(52) U.S. Cl. 705/35

(57) ABSTRACT

A system and method of providing to a consumer or other debtor protection against use of the debtor's identity to establish credit using an intermediary that is adapted to communicate with both the debtor and a potential credit grantor. There is a registration process in which the debtor registers with the intermediary; the registration includes user identification information and a level of protection that is authorized by the debtor on new credit. A credit grantor clearance process follows, in which a credit grantor that has been asked to extend credit to the debtor clears the request with the intermediary before issuing the new credit.

### CROSS REFERENCE TO RELATED APPLICATION

This application claims priority of Provisional patent application Ser. Nos. 60/751,416 filed Dec. 15, 2005, and 60/795,232 filed Apr. 26, 2006, the disclosures of which are incorporated herein by reference.

### FIELD OF THE INVENTION

The invention relates to a system and method that allows a potential debtor to set credit access in advance, to help thwart problems due to credit theft.

### BACKGROUND OF THE INVENTION

There are several types of identity theft that affect millions every year. One type, termed “New Account Identity Theft”, occurs when an impostor obtains a new credit line issued in the victim's name. In such cases, the victimized consumers must spend large amounts of time and effort cleaning up the mess. Millions of Americans discover they were victims of New Account Identity Theft annually, with billions in estimated losses to credit grantors annually. These numbers establish the need for more consumer control over new credit accounts.

There are several new credit account control processes that are currently available to consumers, but they were all created because of legislation or regulation and do not give consumers much control. The mandated processes (e.g., file freezes or fraud alerts) are either ineffective or very inconvenient because they interfere with legitimate transactions. There is no other method or system that allows consumers easily establish conditions to control when credit may be issued in their name, or the types of credit that may be issued in their name.

### SUMMARY OF THE INVENTION

The invention comprises a solution to these problems, by creating an intermediary (a “proxy”) that consumers can use to set the conditions under which credit accounts can be issued in their names, and/or the types of credit that can be issued in their name. In the system and method of the invention, credit grantors then check with the intermediary before issuing new accounts or new types of credits.

This invention is directed at helping to prevent identity theft by allowing consumers to control the use of their identity for credit related transactions through a clearinghouse. Consumers will register with the clearinghouse, satisfactorily identify themselves, and then set requirements under which their identity may be used for credit purposes. Participating credit grantors will check with the clearinghouse before issuing credit for an individual and will not issue credit without following the consumer's pre-established guidelines.

The consumer will register with the clearinghouse online or via telephone. The credit grantor will check with the clearinghouse through web services, an exchange of file transfers, or phone calls. The credit grantor will include the consumer's password if provided by the consumer. The clearinghouse will respond to the credit grantor. The response will include an indication that the consumer is not registered, that the transaction is within the registered consumer's guidelines, or that the transaction is outside the consumer's guidelines, along with an explanation. Non-limiting examples of such predetermined guidelines are set forth below.

This invention could be implemented as a business-to business approach, in which a business rather than a consumer is the potential debtor, and registers with the proxy.

This invention features a method of providing to a debtor control over use of the debtor's identity for credit purposes, using an intermediary that is adapted to communicate with both a debtor and a potential credit grantor, comprising a debtor registration process in which the debtor registers with the intermediary, the registration comprising debtor identification information and a level of protection that is authorized by the debtor on new credit, and a credit grantor clearance process in which a credit grantor that has been asked to extend credit to the debtor clears the request with the intermediary before issuing the new credit.

The new credit may, for example, comprise a credit card, a mortgage, a credit line, or an account with a new credit-granting entity. The credit protection can comprise the debtor registration, which prevents a subsequent registration by another person or entity as the debtor, restricting the debtor billing address, or requiring that the credit grantor transmit to the intermediary the debtor's password. The debtor registration process may comprise collecting credit card information from the debtor and successfully accomplishing a charge to such credit card, or collecting the debtor's social security number and checking to see whether a debtor has previously registered under that social security number.

The credit grantor clearance process may comprise the credit grantor sending an encrypted electronic message to the intermediary, the message comprising a unique credit grantor identifier, and in this case may further comprise the intermediary sending an encrypted electronic reply message to the credit grantor, the message comprising the unique credit grantor identifier. The credit grantor clearance process may comprise the intermediary communicating with the credit grantor, the communication comprising an indication of whether the debtor has registered with the intermediary, or may comprise the intermediary communicating with the credit grantor, the communication comprising an indication of whether the requested type of credit was previously authorized by the debtor, or may comprise the intermediary communicating with the credit grantor, the communication comprising an indication of whether the credit grantor was previously authorized by the debtor.

In a more specific embodiment, the invention features a method of providing to a consumer control over the consumer's identity for credit purposes, using an intermediary that is adapted to communicate with both a consumer and a potential credit grantor, comprising a consumer registration process in which the consumer registers with the intermediary, the registration comprising collecting information from the consumer and successfully verifying that information with an external source, and adding consumer information to a database comprising user identification information and a level of protection that is authorized by the consumer on new credit, and a credit grantor clearance process in which a credit grantor that has been asked to extend credit to the consumer clears the request with the intermediary using an encrypted electronic message before issuing the new credit, the clearance process comprising the intermediary communicating with the credit grantor in a communication comprising at least one of an indication of whether the consumer has registered with the intermediary, an indication of whether the requested type of credit was previously authorized by the consumer, and an indication of whether the credit grantor was previously authorized by the consumer.

In yet another embodiment, the invention features a computerized credit type protection system, comprising an intermediary that is adapted to communicate with both a consumer and a potential credit grantor, an intermediary consumer registration account database, in which the consumer registers with the intermediary, the registration comprising adding consumer information to a database comprising user identification information and a level of protection that is authorized by the consumer on new credit, and a means for accomplishing credit grantor clearance, in which a credit grantor that has been asked to extend credit to the consumer clears the request with the intermediary using an encrypted electronic message before issuing the new credit, the clearance process comprising the intermediary communicating with the credit grantor in a communication comprising at least one of an indication of whether the consumer has registered with the intermediary, an indication of whether the requested type of credit was previously authorized by the consumer, and an indication of whether the credit grantor was previously authorized by the consumer.

### BRIEF DESCRIPTION OF THE DRAWINGS

Other objects, features and advantages will occur to those skilled in the art from the following description of the preferred embodiment of the invention, and the accompanying drawings, in which:

FIG. 1 is a flow chart of the consumer registration process with the proxy, according to the preferred embodiment of the invention;

FIG. 2 is a flow chart of the financial institution (credit grantor) verification process, according to the preferred embodiment of the invention; and

FIG. 3 illustrates a system for accomplishing the preferred embodiment of the invention.

### DETAILED DESCRIPTION OF PREFERRED EMBODIMENTS OF THE INVENTION

This invention may be accomplished in a system and method of providing to a consumer or a business control over credit protection, using an intermediary that is adapted to communicate with both the potential debtor and a potential credit grantor. The potential debtor first goes through a registration process, in which the potential debtor registers with the intermediary, the registration comprising user identification information and a level of protection that is authorized on new credit. A potential credit grantor then goes through a clearance process in which a credit grantor that has been asked to extend credit to the potential debtor clears the request with the intermediary before issuing the new credit.

The following describes a preferred embodiment of the system and method of the invention. This is described in terms of a consumer as the potential debtor, but such does not limit the scope of the invention to consumers, as it can apply to any person or entity that desires to protect the circumstances under which credit is issued to the registrant. Also, the several details of the preferred embodiment do not limit the scope of the invention but rather support the invention through the disclosure of a preferred embodiment.

An intermediary, also termed a credit proxy, is intimately involved in the invention. The proxy maintains a database of relevant information provided by the registrants (the potential debtors). Both the potential debtors and the potential credit grantors communicated with the proxy either electronically (typically from computers with internet connections) and/or by telephone, or any other suitable communications media.

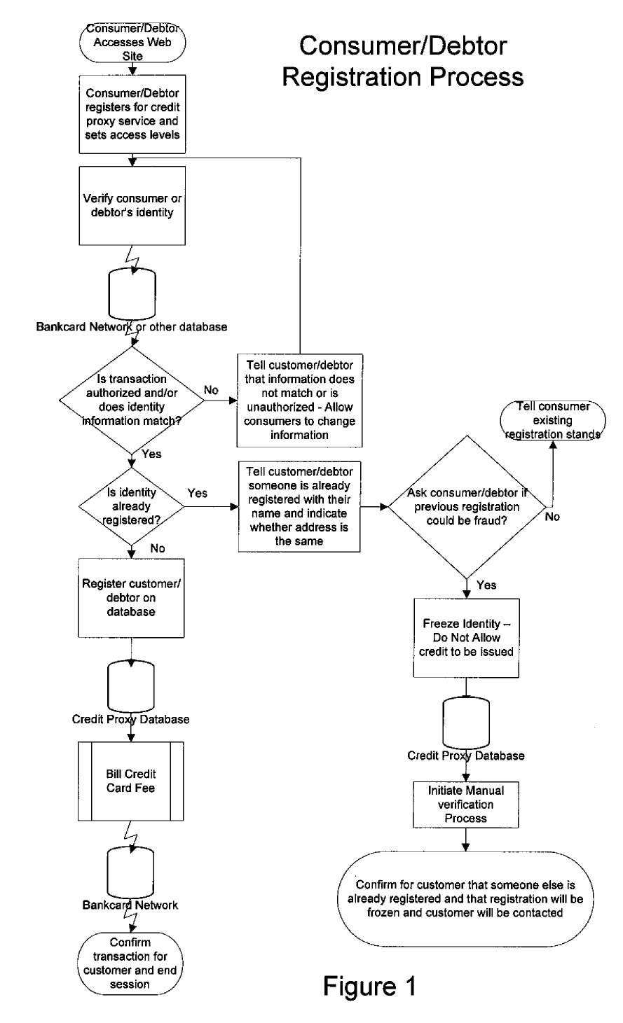

The first step in the process is the consumer registration process. See FIG. 1. The proxy will be available through a web site. Through the web site, using a computer (or potentially using personnel who work for the proxy and key information provided over the telephone), consumers can register, prove their identity and control the process of having credit issued in their name. The consumer will preferably register online for this service through SSL encrypted web pages. A small charge will be made to a credit card. This will be used to verify the consumer's identity. The credit card authorization transaction will happen online through web services while the consumer waits for a response. A response page showing that the transaction and registration was successful or not will be shown.

More specifically, in the preferred embodiment the consumer enters the following required data elements:
Title
First Name
Middle Name
Last Name
Suffix
Address Line 1
Address Line 2
City
State
Zip (+4 at consumer's option)
Date of Birth (mm/dd/yyyy)
Mothers Maiden Name
Other identity information (First Car, First boyfriend/girlfriend, etc.)
Credit Card Type (Table driven options: MC, VI+others)
Credit Card Number (With mod-10 check digit verification built in. For example, if VI is type, 4 must be first digit, if MC is credit card type, 5 must be first digit; others will be available)
Expiration Date (Eight digits: MMDDYYYY)
Card Verification Value (3 or 4 digits)
   The consumer also provides additional registration information, such as:
Username (E-Mail address)
Password (Separate module—could change—8 to 12 alphanumeric—must be at least one alpha and one numeric—ignore case)
   The consumer also chooses between the following levels of credit protection:
Level 0: No protection—but the consumer would prevent anyone else from registering as them
Level 1: Restrict credit lines to their address, which only the consumer could change
Level 2: Require the credit grantor to provide the consumer's password kept at Credit Proxy in order to issue the credit
Level 3: Requires that only certain types of credit be allowed (e.g., mortgages or credit cards)
Level 4: Requires that each creditor be specifically authorized by the consumer on the Credit Proxy web site before credit is extended
   Combinations of the above may also be allowed and additional levels may also be allowed.

The proxy will also include language indicating agreement to the terms referred to on the “Terms” page. After hitting the “submit” button, there will be an authorization process and the confirmation page will be triggered.

An authorization attempt will be made, for example using the MC/Visa network, for the charge, using address verification. If an authorization is not obtained, the system will display a message that the authorization was not approved and loop back to the input page to allow the customer to change the information and try again. A maximum of three attempts will be allowed. If three attempts are unsuccessful the session will be ended. If the authorization is received, the registrant will be taken to the next step. Additional security measures may be added.

If the Credit Card is authorized, confirming the identity of the registrant, a search of the proxy database will be conducted to see if the social security number is already registered. If there is no existing registration for that social security number, the transaction should be applied to the database, setting the required security level. If there is an existing registration with that social security number, this implies that either the registrant has already registered or that there is or was a fraudulent registration. In this case, a message will be displayed to the consumer that there is someone already registered with their name and address or not. The consumer will be asked if the previous registration could be a fraud. If so, the existing registration would be frozen and an exception report for manual work would be produced. If not, a message would be displayed to the consumer that the existing registration remains in force.

If the registration was successful, a confirmation page will be displayed, to confirm the registration information and create a billing transaction through the network.

A similar process to the above may be made available through a telephone call center.

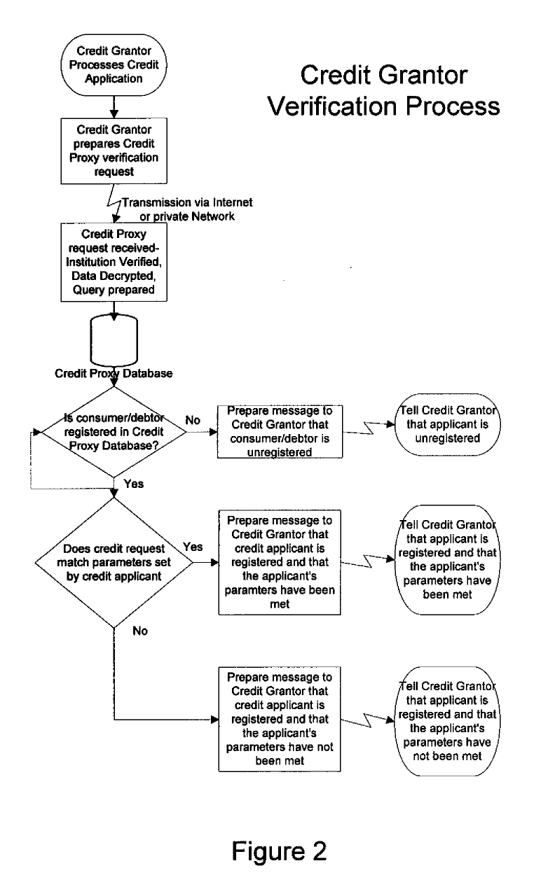

After the consumer has registered, any potential credit grantor can access the proxy to determine whether a requested credit has been authorized by the registrant. See FIG. 2. This process begins by the potential credit grantor sending an encrypted message to the proxy's application server over the Internet. The transaction is encrypted using a key to guarantee the authenticity of the transmitter. The proxy's application server immediately returns a reply.

More specifically, in the preferred embodiment, the potential credit grantor enters the following required data elements:
Potential Grantee's SS: 999-99-999
Potential Grantee's Name: First Name, Middle, Last Name, Suffix
Credit Type (2 character alphanumeric digit code); to be validated against a table
Date of request: (Date field: 99/99/9999) validated for valid date equal to or before current date
Potential Grantee's Address (Address Line 1, Address Line 2, City, State, Zip (5 or 9 digits)
Credit Grantor ID Number (Table Driven—1 per Credit Grantor to be assigned by Credit Proxy Admin.—used to validate against a table and for billing: 999999)
Credit Grantor's unique reference number (1 per Credit request—to be used by credit grantor to match back to the original request—should be 20 character a/n)

The proxy queries its database and composes and transmits to the credit grantor an appropriate response. The fields contained in the response transaction comprise:
Response Code (999) (Others may be added):
   000 Invalid transaction—fails validation tests
   100 Consumer not registered with proxy service
   201 Do Not Issue—No Password sent
   202 Do Not Issue—Incorrect Password
   203 Do Not Issue—Incorrect Address
   204 Do Not Issue—Incorrect Type of Credit (e.g., only mortgages are authorized by consumer, and a credit card was requested)
   205 Do Not Issue—Incorrect Issuer (e.g., Bank A is authorized by consumer, credit requested by Bank B)
   210 Response pending Permission—resubmit after 24 hours
   320 Issue
Credit Grantor's Unique reference number (20 character alphanumeric—from input)
Date of request: (Date field: 99/99/9999—Taken from input)
   The above would be an encrypted web service, and also be available in batch via FTP (File Transfer Protocol).

The proxy database requires appropriate security. New industry standards require that this type of data be stored in encrypted form on the database so that if it is somehow stolen, it will be of no use.

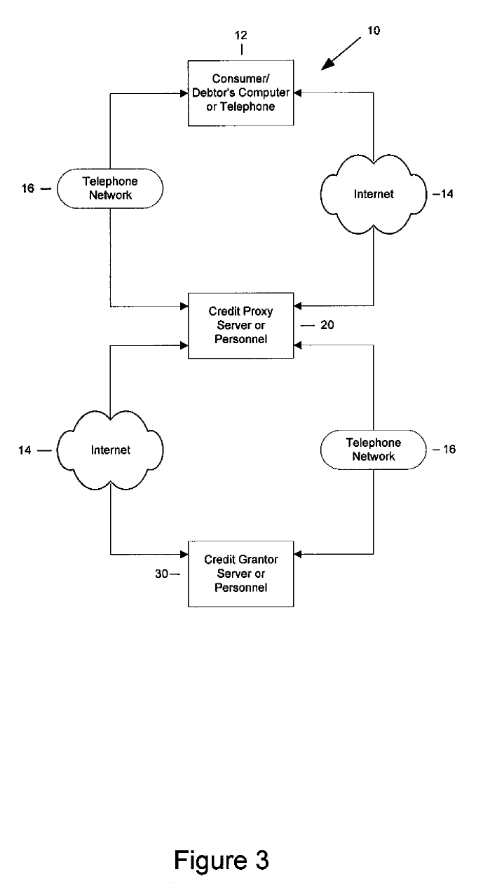

FIG. 3 schematically depicts a system that can accomplish the invention. System 10 includes the debtor's computer or telephone 12, which communicated with the proxy 20 over the internet 14 or the telephone network 16. Similarly, the credit grantor 30 can communicate with proxy 20 over the internet 14 or the telephone network 16. A database of registered debtor's resides on proxy server 20.

Although specific features of the invention are shown in some figures and not others, this is for convenience only, as some features may be combined with any or all of the other features in accordance with the invention.

Recitation of ranges of values herein are merely intended to serve as a shorthand method of referring individually to each separate value falling within the range, unless otherwise indicated herein, and each separate value is incorporated into the specification as if it were individually recited herein.

The use of any and all examples, or exemplary language (e.g., “such as”) provided herein, is intended merely to better illustrate the invention and does not pose a limitation on the scope of the invention.

A variety of modifications to the embodiments described herein will be apparent to those skilled in the art from the disclosure provided herein. Thus, the invention may be embodied in other specific forms without departing from the spirit or essential attributes thereof.

What is claimed is:

1. A method of providing to a debtor control over use of the debtor's identity for credit purposes, using an intermediary that is adapted to communicate with both a debtor and a potential credit grantor, comprising:
a debtor registration process in which the debtor registers with the intermediary, the registration comprising debtor identification information and a level of protection that is authorized by the debtor on new credit; and
a credit grantor clearance process in which a credit grantor that has been asked to extend credit to the debtor clears the request with the intermediary before issuing the new credit.

2. The method of claim 1 wherein the new credit comprises a credit card.

3. The method of claim 1 wherein the new credit comprises a credit line.

4. The method of claim 1 wherein the new credit comprises a mortgage.

5. The method of claim 1 wherein the new credit comprises an account with a new credit-granting entity.

6. The method of claim 1 wherein the credit protection comprises the debtor registration, which prevents a subsequent registration by another person or entity as the debtor.

7. The method of claim 1 wherein the credit protection comprises restricting the debtor billing address.

8. The method of claim 1 wherein the credit protection comprises requiring that the credit grantor transmit to the intermediary the debtor's password.

9. The method of claim 1 wherein the debtor registration process comprises collecting the debtor's social security number and checking to see whether a debtor has previously registered under that social security number.

10. The method of claim 1 wherein the credit grantor clearance process comprises the credit grantor sending an encrypted electronic message to the intermediary, the message comprising a unique credit grantor identifier.

11. The method of claim 10 wherein the credit grantor clearance process further comprises the intermediary sending an encrypted electronic reply message to the credit grantor, the message comprising the unique credit grantor identifier.

12. The method of claim 1 wherein the credit grantor clearance process comprises the intermediary communicating with the credit grantor, the communication comprising an indication of whether the debtor has registered with the intermediary.

13. The method of claim 1 wherein the credit grantor clearance process comprises the intermediary communicating with the credit grantor, the communication comprising an indication of whether the requested type of credit was previously authorized by the debtor.

14. The method of claim 1 wherein the credit grantor clearance process comprises the intermediary communicating with the credit grantor, the communication comprising an indication of whether the credit grantor was previously authorized by the debtor.

15. The method of claim 1 wherein the debtor registration process comprises collecting credit card information from the debtor and successfully accomplishing a charge to such credit card.

16. A method of providing to a consumer control over the consumer's identity for credit purposes, using an intermediary that is adapted to communicate with both a consumer and a potential credit grantor, comprising:
a consumer registration process in which the consumer registers with the intermediary, the registration comprising collecting information from the consumer and successfully validating that information with another information source, and adding consumer information to a database comprising user identification information and a level of protection that is authorized by the consumer on new credit; and
a credit grantor clearance process in which a credit grantor that has been asked to extend credit to the consumer clears the request with the intermediary using an encrypted electronic message before issuing the new credit, the clearance process comprising the intermediary communicating with the credit grantor in a communication comprising at least one of:
i. an indication of whether the consumer has registered with the intermediary;
ii. an indication of whether the requested type of credit was previously authorized by the consumer; and
iii. an indication of whether the credit grantor was previously authorized by the consumer.

17. A computerized credit type protection system, comprising:
an intermediary that is adapted to communicate with both a consumer and a potential credit grantor;
an intermediary consumer registration account database, in which the consumer registers with the intermediary, the registration comprising adding consumer information to a database comprising user identification information and a level of protection that is authorized by the consumer on new credit; and
a means for accomplishing credit grantor clearance, in which a credit grantor that has been asked to extend credit to the consumer clears the request with the intermediary using an encrypted electronic message before issuing the new credit, the clearance process comprising the intermediary communicating with the credit grantor in a communication comprising at least one of:
i. an indication of whether the consumer has registered with the intermediary;
ii. an indication of whether the requested type of credit was previously authorized by the consumer; and
iii. an indication of whether the credit grantor was previously authorized by the consumer.
